(19) United States
(12) Patent Application Publication
(10) Pub. No.: US 2022/0229771 A1
(43) Pub. Date: Jul. 21, 2022

(54) PATH DETERMINATION DEVICE AND COMPUTER READABLE MEDIUM

(71) Applicant: Mitsubishi Electric Corporation, Tokyo (JP)

(72) Inventor: Kiyotaka MORITA, Tokyo (JP)

(73) Assignee: Mitsubishi Electric Corporation, Tokyo (JP)

(21) Appl. No.: 17/716,173

(22) Filed: Apr. 8, 2022

Related U.S. Application Data
(63) Continuation of application No. PCT/JP2019/049477, filed on Dec. 17, 2019.

(51) Int. Cl. G06F 11/36; G06F 11/34; G06F 8/71

(52) U.S. Cl. CPC G06F 11/3688; G06F 8/71; G06F 11/3409; G06F 11/3692

(57) ABSTRACT

A path determination device (1) includes a first difference extraction unit (21), a path extraction unit (22), and a determination unit (23). The first difference extraction unit (21) acquires a plurality of difference parts between source code of a first program and source code of a second program and first coverage information of the second program. With reference to the first coverage information, the first difference extraction unit (21) extracts, from the plurality of difference parts, first difference parts included in the first coverage information. The path extraction unit (22) extracts, for each of the first difference parts (31), a plurality of influence paths (32) to be influenced by the first difference part, from the source code of the second program. The determination unit (23) acquires second coverage information of the second program and excludes the influence path included in the second coverage information among the plurality of influence paths extracted by the path extraction unit (22).

### CROSS REFERENCE TO RELATED APPLICATIONS

This application is a Continuation of PCT International Application No. PCT/JP2019/049477 filed on Dec. 17, 2019, which is hereby expressly incorporated by reference into the present application.

### TECHNICAL FIELD

The present invention relates to a path determination device and path determination program for determining a path including a difference part between a program before version update and a program after version update.

### BACKGROUND ART

In conventional techniques, for a program having a performance problem, difference information between a source code at a part where the performance problem is present before change and a source code after change is presented to a user.

However, it is difficult to narrow down causes of the performance problem only with simple difference information. In Patent Literature 1, how the difference information is calculated is not described in detail. As a difference information calculation method, the following method (1) or (2) can be thought. However, (1) and (2) each have the following problems.

(1) Only a difference regarding a function having the performance problem is extracted. However, if a change of another function influencing the function having the performance problem is the cause, there is a problem in which this cause cannot be presented.
(2) All differences due to changes including those of functions influencing the performance problem are presented. However, there is a problem in which the number of differences to be presented increases and the user cannot narrow down causes. In (2), even a difference not related to the performance problem is presented. Thus, there is a problem in which how the difference serving as a factor responsible for the performance problem influences a function cannot be grasped.

### CITATION LIST

### Patent Literature

Patent Literature 1: JP 2018-112959

### SUMMARY OF INVENTION

### Technical Problem

An object of this invention is to facilitate identification of a cause for a program performance problem by a user.

### Solution to Problem

A path determination device to the present invention includes

a first difference extraction unit to acquire a plurality of difference parts each indicating a dissimilar part between a source code of a first program and a source code of a second program acquired by version-updating the first program and first coverage information indicating a plurality of rows executed by a first performance test for testing the second program in its entirety by using a first test condition and, with reference to the first coverage information, from the plurality of difference parts, to extract a plurality of first difference parts indicating a plurality of difference parts on which the first performance test has been executed;

a path extraction unit to extract, for each of the first difference parts, an influence path indicating a chain of a plurality of elements to be influenced by the first difference part, from a plurality of elements configuring the source code of the second program; and

a determination unit to acquire second coverage information indicating a plurality of rows on which a second performance test using a second test condition different from the first test condition has been conducted among a plurality of rows of the source code of the second program and to determine an influence path included in the second coverage information among the plurality of influence paths extracted for each of the first difference parts.

### Advantageous Effects of Invention

The path determination device of this invention presents difference parts serving as causes for performance problems and influence paths influenced by the difference parts in source codes as being narrowed down. Thus, the path determination device of the present invention can facilitate identification of a cause for the program performance problem by the user.

### BRIEF DESCRIPTION OF DRAWINGS

FIG. 1 is a drawing of Embodiment 1, illustrating a state in which a path determination device 1 is used.

FIG. 2 is a drawing of Embodiment 1, illustrating the hardware structure of the path determination device 1.

FIG. 3 is a drawing of Embodiment 1, being a flowchart illustrating operation of a preparation phase of the path determination device 1.

FIG. 4 is a drawing of Embodiment 1, being a flowchart illustrating operation of an execution phase of the path determination device 1.

FIG. 5 is a drawing of Embodiment 1, being a flowchart illustrating operation of an output phase of the path determination device 1.

FIG. 6 is a drawing of Embodiment 1, illustrating first coverage information 321 in the preparation phase.

FIG. 7 is a drawing of Embodiment 1, illustrating the first coverage information 321 in the preparation phase and difference parts.

FIG. 8 is a drawing of Embodiment 1, illustrating an influence path list 22A in the preparation phase.

FIG. 9 is a drawing of Embodiment 1, illustrating second coverage information 322 in an execution phase 1.

FIG. 10 is a drawing of Embodiment 1, illustrating the influence path list 22A in the execution phase 1.

FIG. 11 is a drawing of Embodiment 1, illustrating operation of an output unit 24 in an output phase 1.

FIG. 12 is a drawing of Embodiment 1, illustrating the second coverage information 322 in an execution phase 2.

FIG. 13 is a drawing of Embodiment 1, illustrating the influence path list 22A in the execution phase 2.

FIG. 14 is a drawing of Embodiment 1, illustrating operation of the output unit 24 in an output phase 2.

FIG. 15 is a drawing of Embodiment 1, supplementing the hardware structure of the path determination device 1.

### DESCRIPTION OF EMBODIMENTS

In the following, an embodiment of the present invention is described by using the drawings. Note that the same or corresponding portions are provided with the same reference character in each drawing. In description of the embodiment, description of the same or corresponding portions is omitted or simplified as appropriate.

### Embodiment 1

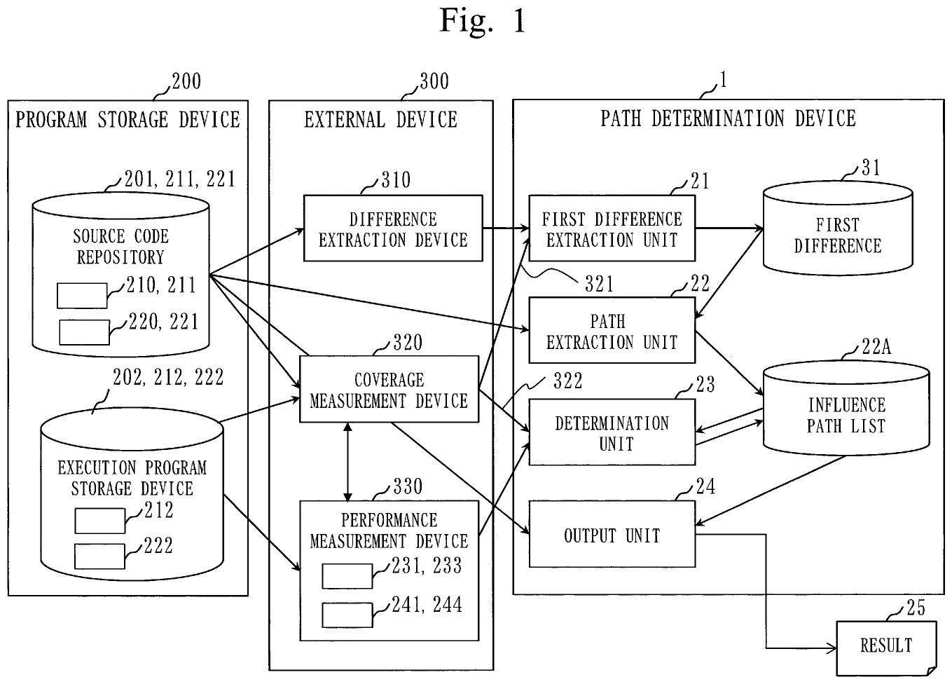

With reference to FIG. 1 to FIG. 15, a path determination device 1 of Embodiment 1 is described.

FIG. 1 illustrates a use form of the path determination device 1 of Embodiment 1. The path determination device 1 is used together with a program storage device 200 and an external device 300.

The program storage device 200 includes a source code repository 201 and an execution program storage device 202. The source code repository 201 has stored therein a source code 211 of a first program 210 and a source code 221 of a second program 220. The execution program storage device 202 has stored therein an execution program 212 of the first program 210 and an execution program 222 of the second program 220. The source code repository 201 and the execution program storage device 202 are storage devices.

The external device 300 includes a difference extraction device 310, a coverage measurement device 320, and a performance measurement device 330. The difference extraction device 310 extracts a difference between the source code 211 of the first program 210 and the source code 221 of the second program 220, and transmits the extracted difference to a first difference extraction unit 21 of the path determination device 1. When the performance measurement device 330 executes the execution program 222 of the second program 220 to measure the performance of the second program 220, the coverage measurement device 320 measures code coverage of the source code 221 of the second program 220. Note that in the following description, code coverage is represented as coverage information. The coverage information is information indicating a source code actually executed, among source codes executed as execution targets. The coverage measurement device 320 transmits the coverage information to the first difference extraction unit 21 and a path extraction unit 22. While monitoring an execution status of the performance measurement device 330, the performance measurement device 330 measures the coverage information of the program as described above. The performance measurement device 330 transmits the test result of performance measurement to a determination unit 23.

The path determination device 1 includes, as functional components, functions of the first difference extraction unit 21, the path extraction unit 22, the determination unit 23, and an output unit 24. These functions will be described further below in description of operation. The first difference extraction unit 21 stores a first difference part 31 and an influence path list 22A, which will be described further below, in a storage device. The determination unit 23 stores the influence path list 22A, which will be described further below, in a storage device. The output unit 24 outputs a result 25.

***Description of Structure***

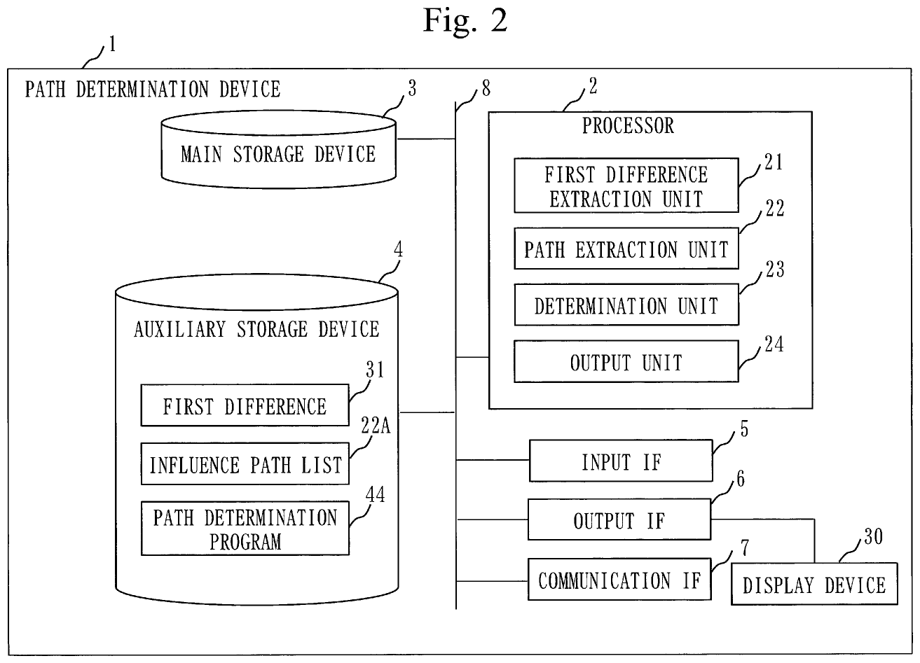

FIG. 2 illustrates the hardware structure of the path determination device 1. With reference to FIG. 2, the hardware structure of the path determination device 1 is described.

The path determination device 1 is a computer. The path determination device 1 includes a processor 2. The path determination device 1 includes, in addition to the processor 2, other pieces of hardware such as a main storage device 3, an auxiliary storage device 4, an input IF 5, an output IF 6, and a communication IF 7. The processor 2 is connected to the other pieces of hardware via a signal line 8 to control the other pieces of hardware.

The path determination device 1 includes, as functional components, the first difference extraction unit 21, the path extraction unit 22, the determination unit 23, and the output unit 24. The functions of the first difference extraction unit 21, the path extraction unit 22, the determination unit 23, and the output unit 24 are achieved by a path determination program 44. The path determination program 44 is stored in the auxiliary storage device 4.

The processor 2 is a device which executes the path determination program 44. The path determination program 44 is a program achieving the functions of the first difference extraction unit 21, the path extraction unit 22, the determination unit 23, and the output unit 24. The processor 2 is an IC (Integrated Circuit) which performs an arithmetic operation process. Specific examples of the processor 2 are a CPU (Central Processing Unit), DSP (Digital Signal Processor), and GPU (Graphics Processing Unit).

Specific examples of the main storage device 3 are an SRAM (Static Random Access Memory) and DRAM (Dynamic Random Access Memory). The main storage device 3 retains the arithmetic operation results of the processor 2.

The auxiliary storage device 4 is a storage device which stores data in a non-volatile manner. Specific examples of the auxiliary storage device 4 is an HDD (Hard Disk Drive). Also, the auxiliary storage device 4 may be a portable recording medium such as an SD (registered trademark) (Secure Digital) memory card, NAND flash, flexible disc, optical disc, compact disc, Blu-ray (registered trademark) disc, or DVD (Digital Versatile Disk). The auxiliary storage device 4 has stored therein the influence path list 22A and the path determination program 44.

The input IF 5 is a port to which data is inputted from each device. The output IF 6 is a port to which various pieces of equipment are connected and from which data is outputted by the processor 2 to various pieces of equipment. In FIG. 2, to the output IF 6, a display device 30 is connected. The communication IF 7 is a communication port for the processor to communicate with other devices.

The processor 2 loads the path determination program 44 from the auxiliary storage device 4 to the main storage device 3, and reads the path determination program 44 from the main storage device 3 for execution. In the main storage device 3, not only the path determination program 44 but also an OS (Operating System) is stored. The processor 2 executes the path determination program 44 while executing the OS. The path determination device 1 may include a plurality of processors which replace the processor 2. The plurality of these processors share the role of execution of the path determination program 44. As with the processor 2, each of the plurality of these processors is a device which executes the path determination program 44. Data, information, signal values, and variable values to be used, processed, or outputted by the path determination program 44 are stored in the main storage device 3, the auxiliary storage device 4, or a register or cache memory in the processor 2.

The path determination program 44 is a program which causes a computer to execute each process, each procedure, or each step obtained by reading “unit” of the first difference extraction unit 21, the path extraction unit 22, the determination unit 23, and the output unit 24 as “process”, “procedure”, or “step”.

Also, a path determination method is a method to be performed by the path determination device 1 as a computer to execute the path determination program 44. The path determination program 44 may be provided as being stored in a computer-readable recording medium or provided as a program product.

***Description of Operation***

The operation of the path determination device 1 is described. The operation procedure of the path determination device 1 corresponds to the path determination method. A program implementing the operation of the path determination device 1 corresponds to the path determination program 44. The operation of the path determination device 1 is formed of a preparation phase, an execution phase, and an output phase as follows.

In the preparation phase, the path determination device 1 extracts the first difference part 31 from a plurality of difference parts acquired from the difference extraction device 310. Also, the path determination device 1 extracts an influence path 32 from the source code 221 of the second program 220. The first difference part 31 is a difference part having a possibility of a cause for a performance problem.

In the execution phase, of the plurality of influence paths 32, the path determination device 1 determines an influence path which is not a cause for a performance problem of the second program 220, and deletes the determined influence path 32 from the plurality of influence paths 32.

In output phase, the path determination device 1 outputs the result with the determined influence path deleted as not being a cause for a performance problem. The path determination device 1 executes the preparation phase once, and executes the execution phase and the output phase once or more times.

In the following, each phase is described.

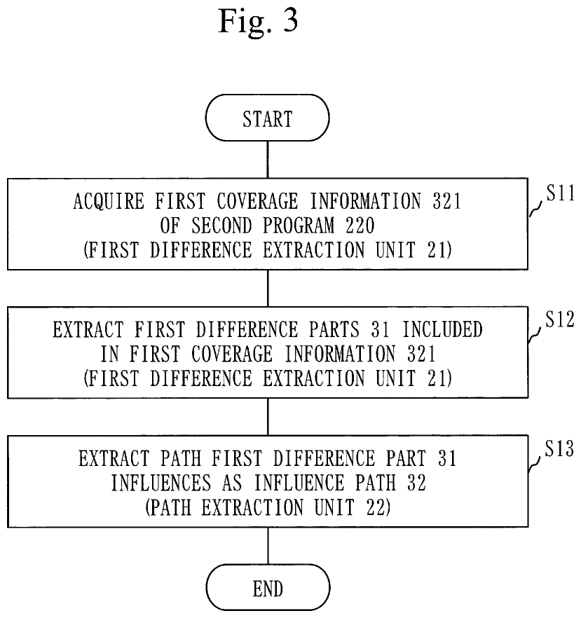

FIG. 3 is a flowchart illustrating the operation of the preparation phase.

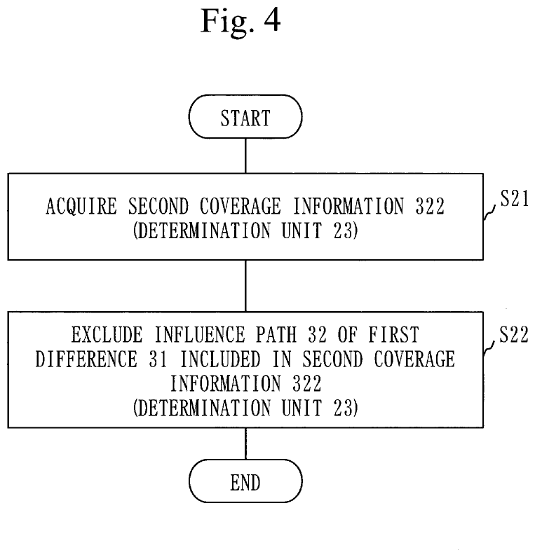

FIG. 4 is a flowchart illustrating the operation of the execution phase.

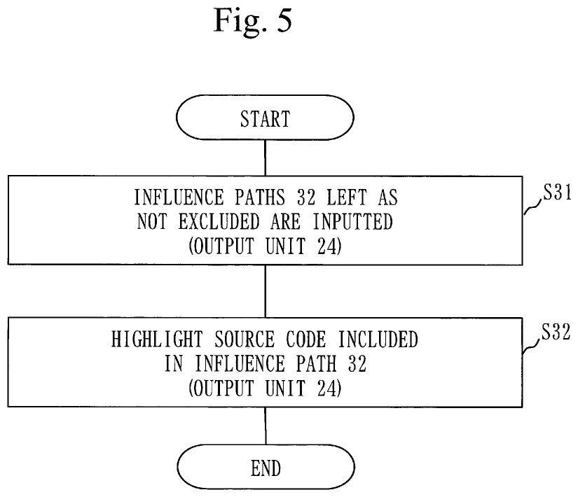

FIG. 5 is a flowchart illustrating the output phase operation. With reference to FIG. 3, the operation of the path determination device 1 in the preparation phase is described.

<Preparation Phase>

At step S11, the first difference extraction unit 21 acquires, from the difference extraction device 310, a plurality of difference parts each indicating a dissimilar part between the source code 211 of the first program 210 and the source code 221 of the second program 220. The source code 211 of the first program 210 and the source code 221 of the second program 220 are stored in the source code repository 201 of FIG. 1. The execution program storage device 202 has stored therein the execution program 212 of the source code 211 and the execution program 222 of the source code 221. The second program 220 is a program acquired by version-updating the first program 210.

The difference extraction device 310 uses the source code 211 and the source code 221 to extract a plurality of difference parts between the source code 211 and the source code 221. At step S11, the first difference extraction unit 21 acquires the plurality of difference parts from the difference extraction device 310.

Also at step S11, as illustrated in FIG. 1, the first difference extraction unit 21 acquires first coverage information 321 from the coverage measurement device 320. The first coverage information 321 is information indicating a plurality of rows executed by a first performance test for conducting a performance test on the second program 220 in its entirety by using a first test condition. The performance measurement device 330 of FIG. 1 executes a first performance test 233 using a first test condition 231. The coverage measurement device 320 is a device which measures a source code executed when the source code is executed. The coverage measurement device 320 measures the first coverage information 321.

The first program 210 is determined as satisfying a performance required for the first program 210, by the performance measurement device 330 which measures the performance of the program to determine whether the program satisfies the performance. The second program 220 is determined as not satisfying a performance required for the second program 220, by the performance measurement device 330 from the measurement result of the first performance test 233 by the performance measurement device 330. Further, the second program 220 is determined as satisfying a performance required for the second program 220, by the performance measurement device 330 from the measurement result of a second performance test 244 by the performance measurement device 330. At step S21, which will be described further below, the determination unit 23 acquires, as second coverage information 322, coverage information determined as satisfying the required performance of the second program 220 from the coverage measurement device 320.

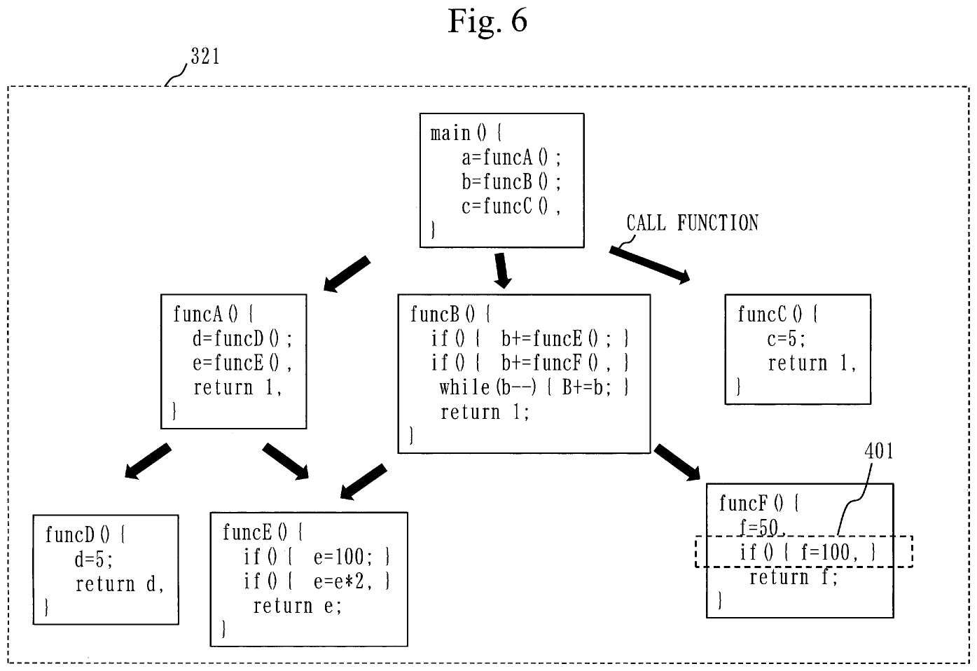

FIG. 6 illustrates an example of the first coverage information 321 of the second program 220 acquired by the first difference extraction unit 21. In the first coverage information 321, it is indicated that a code 401 is not executed in the source code 221 of the second program 220. In FIG. 6, codes other than the code 401 are executed.

At step S12, the first difference extraction unit 21 refers to the first coverage information 321 to extract, from a plurality of difference parts, a plurality of first difference parts 31 indicating a plurality of difference parts on which the first performance test 233 has been executed. Note that the difference parts are denoted as differences in the drawings.

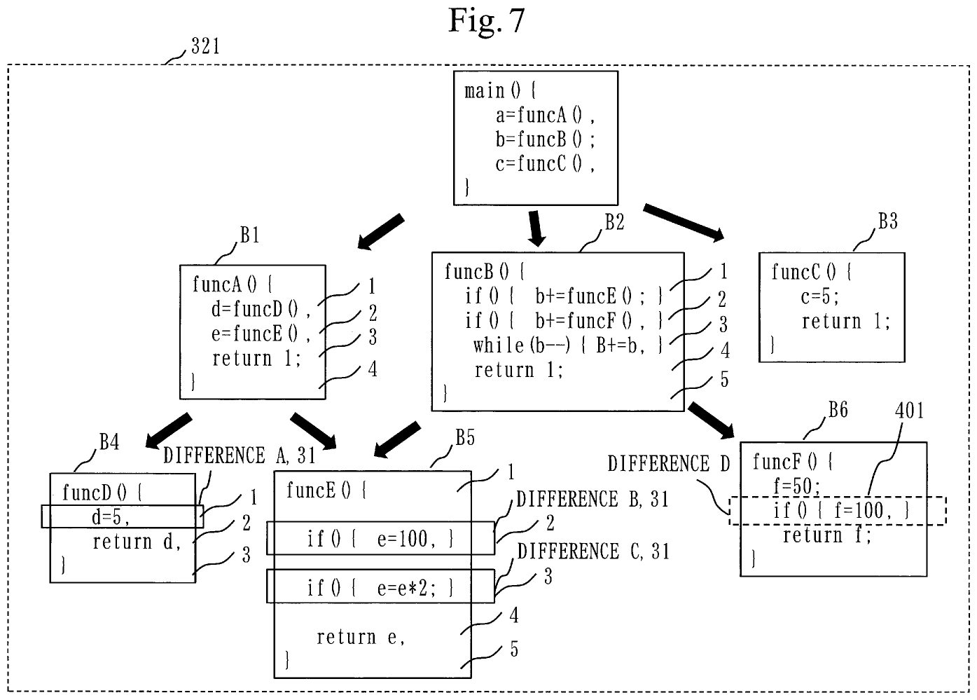

FIG. 7 is a drawing illustrating the first difference parts 31. The first difference extraction unit 21 acquires, at step S11, a difference part A, a difference part B, a difference part C, and a difference part D as a plurality of difference parts. The first difference extraction unit 21 learns, from the first coverage information 321, that the difference part D is the code 401 not executed. Thus, the first difference extraction unit 21 extracts the difference part A, the difference part B, and the difference part C as the first difference parts 31 from the difference part A, the difference part B, the difference part C, and the difference part D. The difference part D has not been executed, and is thus excluded from process targets. This is because the difference part D has not been executed and thus does not influence the performance problem of the second program 220.

At step S13, the path extraction unit 22 uses dependency analysis to extract, from a plurality of elements configuring the source code 221 of the second program 220, the influence path 32 for each first difference part 31. The influence path 32 indicates a chain of a plurality of elements to be influenced by the first difference part 31. The path extraction unit 22 extracts a chain of functions as the influence path 32.

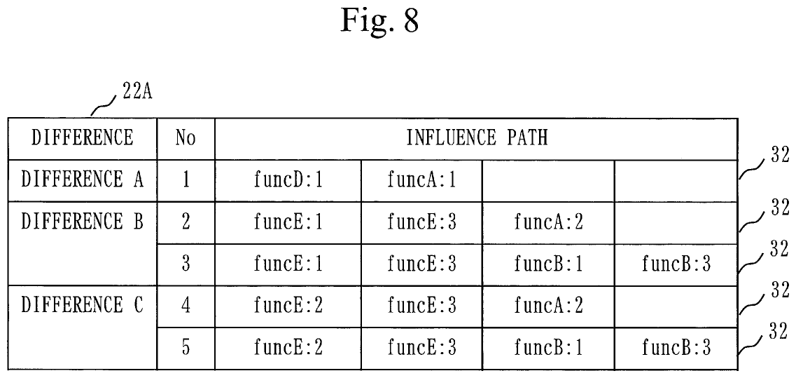

FIG. 8 illustrates the influence path list 22A indicating a list of influence paths 32 extracted by the path extraction unit 22 based on the first coverage information 321 of FIG. 7. The plurality of elements configuring the source code 221 are text elements configuring the source code 221 illustrated in FIG. 8. The path extraction unit 22 records the influence paths 32 extracted by the dependency analysis in the influence path list 22A. The path extraction unit 22 records the influence paths 32 in units of extending over a function and a basic block. In recording, the path extraction unit 22 records a function name and a row number. In the following, with reference to FIG. 7, extraction of the influence paths 32 by the path extraction unit 22 is described. In FIG. 7, it is assumed that a block B1 to a block B6 of each function are provided with row numbers. Row numbers are depicted in the blocks B1, B2, B4, and B5.

Note that recording of a function name and a row number by the path extraction unit 22 is one example. That is, a method by the path extraction unit 22 for identifying the influence path 32 by using the function name and the row number is one example.

<Difference Part A>

The path extraction unit 22 extracts the influence path 32 dependent on the difference part A that is the first difference part 31 in the following manner. The path extraction unit 22 recognizes the difference part A as the first row of funcD. The path extraction unit 22 recognizes that the difference part A influences “d=funcD( );” on the first row of funcA. The path extraction unit 22 records, in the influence path list 22A, the row number of the text element in the function block in which the text element to be influenced is included and the function name included in the function block as the influence path 32. The path extraction unit 22 records a set of “function name:row number”. The start point of the influence path 32 is the row number of the difference part A in the function block in which the difference part A is included and the function name included in that function block. For the difference part A, the path extraction unit 22 records the influence path 32 of “funcD:1”, “funcA:1”. In the following, “function name:row number” may be used for representation.

<Difference Part B>

The path extraction unit 22 extracts the influence path 32 dependent on the difference part B that is the first difference part 31 in the following manner. The path extraction unit 22 recognizes the difference part B as “funcE:1”. The path extraction unit 22 recognizes that the difference part B influences “return e;” on the third row of funcE. The path extraction unit 22 recognizes that the influence part is “funcE:3”. The path extraction unit 22 recognizes that “funcE:3” influences “e=funcE( );” on the second row of funcA. The path extraction unit 22 recognizes that the influence part is “funcA:2”. Thus, the path extraction unit 22 extracts a path of “funcE:1”, “funcE:3”, “funcA:2” as the influence path 32.

<Difference Part B>

The path extraction unit 22 extracts another one influence path 32 dependent on the difference part B that is the first difference part 31 in the following manner. The path extraction unit 22 recognizes the difference part B as “funcE:1”. The path extraction unit 22 recognizes that the difference part B influences “return e” on the third row of funcE. The path extraction unit 22 recognizes that the influence part is “funcE:3”. The path extraction unit 22 recognizes that “funcE:3” influences “if( ){b+=funcE( );}” on the first row of funcB. The path extraction unit 22 recognizes that the influence part is “funcB:1”. The path extraction unit 22 recognizes that “funcB:1” influences “while (b−−){B+=b;}” on the third row of funcB. The path extraction unit 22 recognizes that the influence part is “funcB:3”. Thus, the path extraction unit 22 extracts a path of “funcE:1”, “funcE:3”, “funcB:1”, “funcB:3” as the influence path 32.

<Difference Part C>

The path extraction unit 22 extracts the influence path 32 dependent on the difference part C that is the first difference part 31 in the following manner. The path extraction unit 22 recognizes the difference part C as “funcE:2”. The path extraction unit 22 recognizes that the difference part C influences “return e” on the third row of funcE. The path extraction unit 22 recognizes that the influence part is “funcE:3”. The path extraction unit 22 recognizes that “funcE:3” influences “e=funcE( );” on the second row of funcA. The path extraction unit 22 recognizes that the influence part is “funcA:2”. Thus, the path extraction unit 22 extracts a path of “funcE:2”, “funcE:3”, “funcA:2” as the influence path 32.

<Difference Part C>

The path extraction unit 22 extracts another one influence path 32 dependent on the difference part C that is the first difference part 31 in the following manner. The path extraction unit 22 recognizes the difference part C as “funcE:2”. The path extraction unit 22 recognizes that the difference part C influences “return e” on the third row of funcE. The path extraction unit 22 recognizes that the influence part is “funcE:3”. The path extraction unit 22 recognizes that “funcE:3” influences “if( ){b+=funcE( )}” on the first row of funcB. The path extraction unit 22 recognizes that the influence part is “funcB:1”. The path extraction unit 22 recognizes that “funcB:1” influences “while (b−−){B+=b;}” on the third row of funcB. The path extraction unit 22 recognizes that the influence part is “funcB:3”. Thus, the path extraction unit 22 extracts a path of “funcE:2”, “funcE:3”, “funcB:1”, “funcB:3” as the influence path 32.

<Execution Phase 1>

In the execution phase 1, the determination unit 23 uses the second coverage information 322, which is coverage information of the second performance test 244 conducted as a performance test using a parameter different from that of the first performance test 233 in which a performance problem has been detected in the second program 220, or as a partial performance test. “The second coverage information 322” indicates a plurality of rows on which the second performance test 244 using a second test condition 241 different from the first test condition 231 has been conducted among a plurality of rows of the source code 221 of the second program 220. The second coverage information 322 is coverage information of the source code 221 in the second performance test 244 determined as satisfying the requirement performance of the second program 220. The determination unit 23 excludes an influence path included in the second coverage information 322 from the influence path list 22A. This is because a performance problem does not emerge even if the second performance test 244 executed in the range of the second coverage information 322 includes the influence path 32 and thus the influence path 32 included in the second coverage information 322 is thought not to cause a performance problem.

With reference to FIG. 4, the execution phase 1 is described. At step S21, as illustrated in FIG. 1, the determination unit 23 acquires the second coverage information 322.

At step S22, of the plurality of influence paths 32 extracted for each first difference part 31, the determination unit 23 determines the influence path 32 included in the second coverage information 322. Of the plurality of influence paths 32, the determination unit 23 excludes the determined influence path 32 included in the second coverage information 322 from the plurality of influence paths 32. Specifically, the process is as follows.

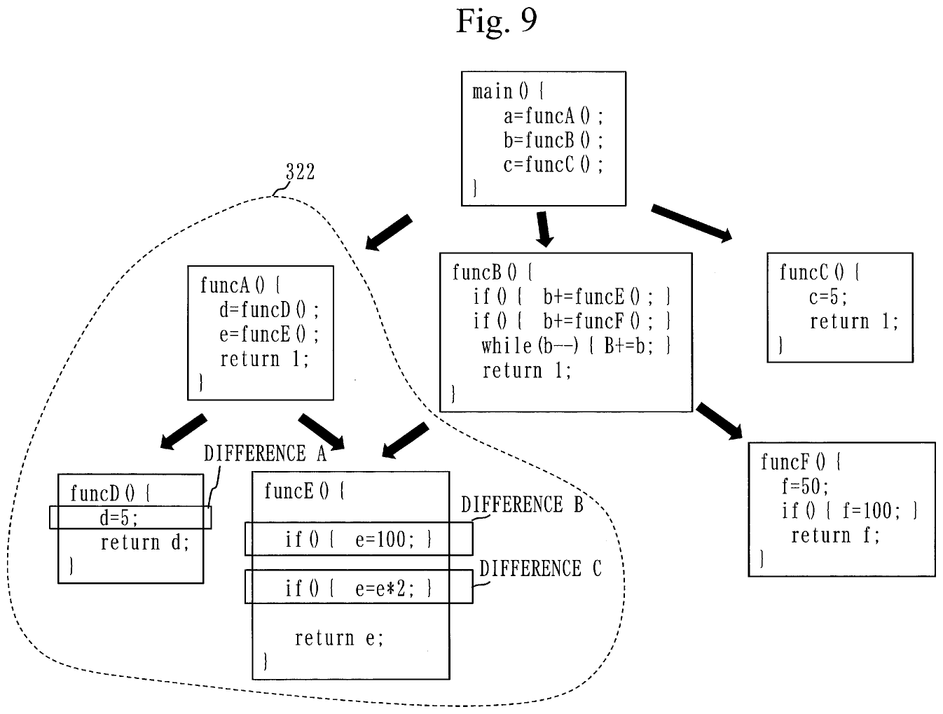

FIG. 9 illustrates the second coverage information 322. The second coverage information 322 is coverage information when a performance test on a certain parameter for funcA proves no problem. “A certain parameter” for funcA corresponds to a second test condition 242. The determination unit 23 acquires the second coverage information 322 at step S21.

At step S22, the determination unit 23 performs the following process. The determination unit 23 determines the influence paths 32 included in the second coverage information 322.

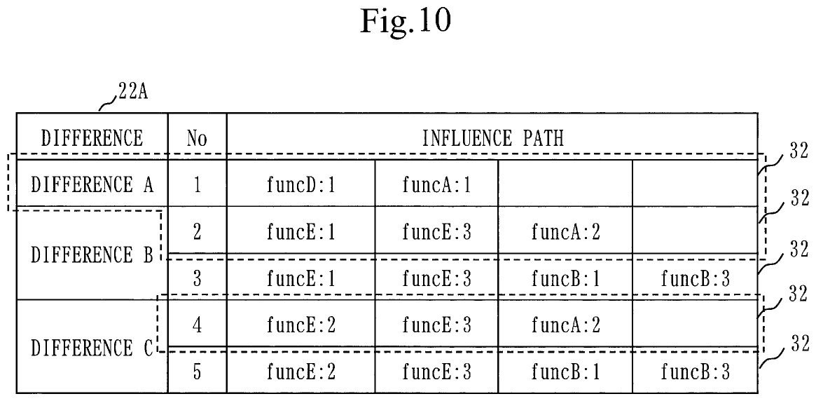

FIG. 10 illustrates the influence path list 22A in the execution phase 1. As illustrated in FIG. 10, the determination unit 23 determines, from the second coverage information 322, the influence path 32 of “funcD:1”, “funcA:1” for <difference part A>. The determination unit 23 determines, from the second coverage information 322, the influence path 32 of “funcE:1”, “funcE:3”, “funcA:2” for <difference part B>. The determination unit 23 determines, from the second coverage information 322, the influence path 32 of “funcE:2”, “funcE:3”, “funcA:2” for <difference part C>.

The determination unit 23 excludes the plurality of influence paths 32 determined based on the second coverage information 322 from the influence path list 22A. It is indicated that the influence paths in a range of broken lines in FIG. 10 are excluded by the determination unit 23. In the influence path list 22A of FIG. 10, the influence paths 32 of No. 3 and No. 5 are left.

<Output Phase 1>

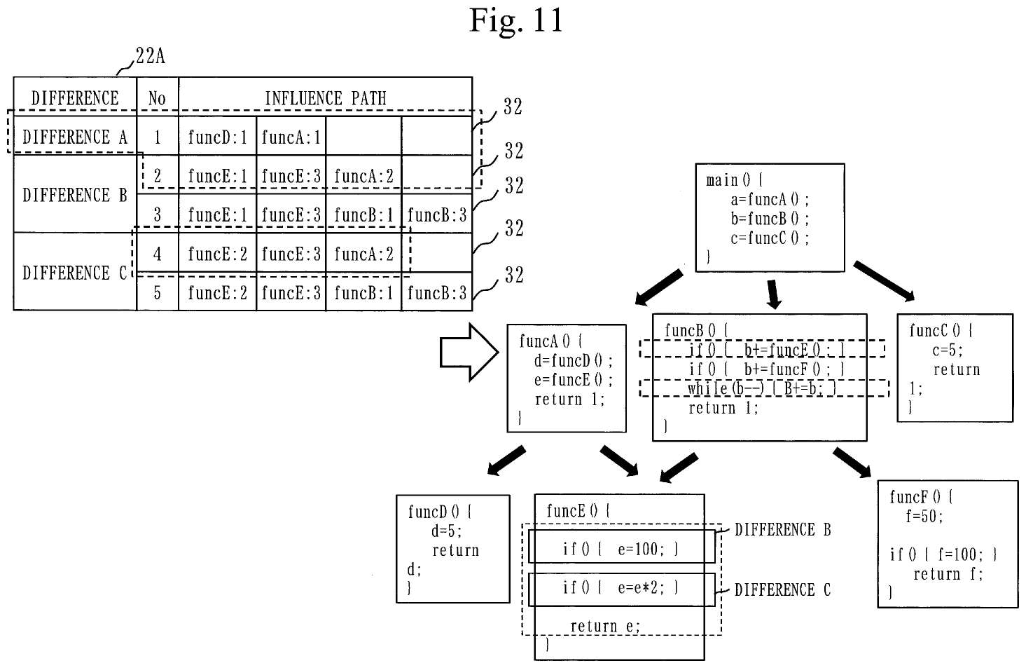

FIG. 11 illustrates the operation of the output unit 24 in the output phase 1. With reference to FIG. 5 and FIG. 11, the operation of the output unit 24 is described. At step S31, to the output unit 24, the influence paths 32 of No. 3 and No. 5 left as not excluded are inputted from the determination unit 23. At step S32, the output unit 24 outputs the result 25 in which the influence paths 32 included in the second coverage information 322 is excluded from the plurality of influence paths 32. Specifically, the output unit 24 causes source code included in the inputted influence paths 32 to be highlighted on the display device 30. In FIG. 11, the output unit 24 causes codes surrounded by broken lines to be highlighted. Display on the display device 30 is an example of output, and the output unit 24 may output the result 25 to the auxiliary storage device 4 or may output the result 25 to another storage device other than the auxiliary storage device 4. From the result of the execution phase 1 described above, as illustrated in FIG. 10 and FIG. 11, the influence paths 32 of No. 1, No. 2, and No. 4 are excluded from the influence path list 22A.

<Execution Phase 2>

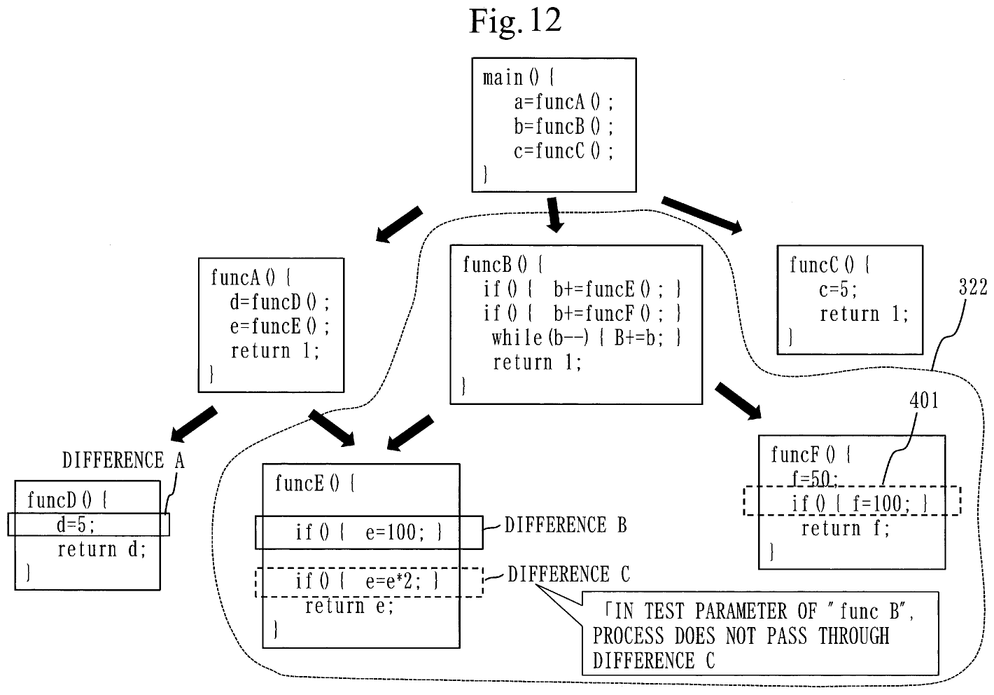

FIG. 12 illustrates the second coverage information 322 in the execution phase 2. The second coverage information 322 is coverage information when a performance test on a certain parameter for funcB proves no problem. “A certain parameter” for funcB corresponds to the second test condition 242. The determination unit 23 acquires the second coverage information 322 at step S21.

At step S22 in the execution phase 2, the determination unit 23 performs the following process. The determination unit 23 determines the influence paths 32 included in the second coverage information 322.

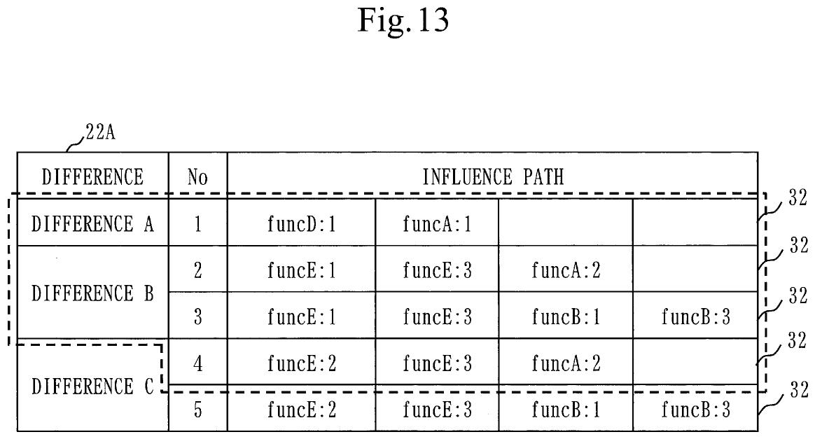

FIG. 13 illustrates the influence path list 22A in the execution phase 2. The determination unit 23 determines, from the second coverage information 322, the influence path 32 of “funcE:1”, “funcE:3”, “funcB:1”, “funcB:3” for the difference part B. The determination unit 23 excludes this influence path 32 determined based on the second coverage information 322 from the influence path list 22A. The state after exclusion is in the influence path list 22A of FIG. 13. Note that the influence path 32 of No. 5 in the influence path list 22A of FIG. 13 does not pass through the difference part C with the parameter for funcB in this second test condition 242. Thus, the difference part C of No. 5 is not deleted from the influence path list 22A. In the influence path list 22A of FIG. 13, only the influence path 32 of No. 5 is left.

<Output Phase 2>

In the output phase 2, of the influence path list 22A, only the influence path 32 of No. 5 is left. At step S31, the output unit 24 receives an input of the result from the determination unit 23. At step S32, the output unit 24 outputs the difference part C as a source of the influence path 32 of No. 5 to the display device for output by highlighting.

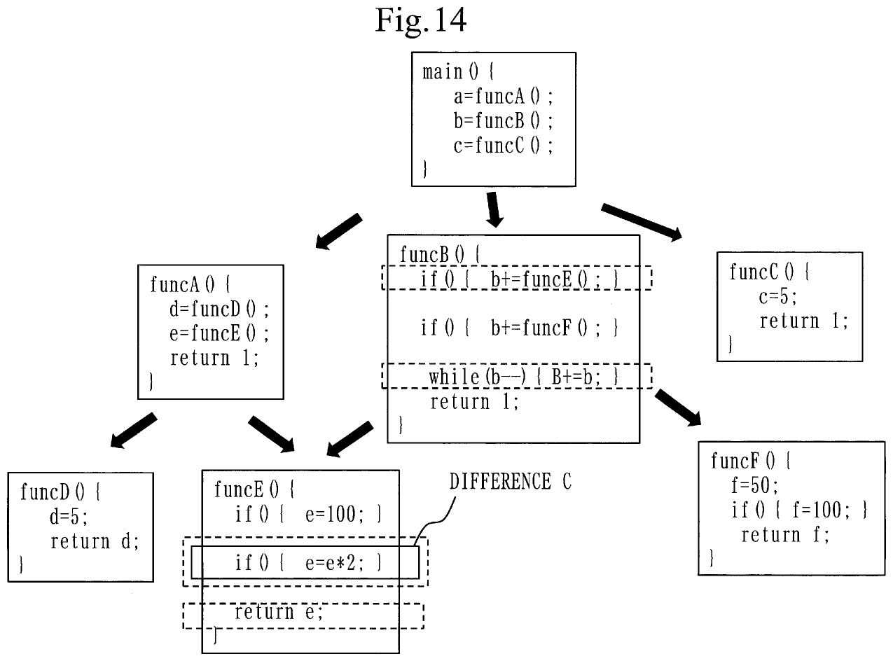

FIG. 14 illustrates the operation of the output unit 24 in the output phase 2. The output unit 24 causes codes surrounded by broken lines in FIG. 14 to be displayed on the display device 30 by highlighting. As a result of the execution phase 2 described above, the influence paths 32 in the range of the broken lines in FIG. 13 are executed from the influence path list 22A.

### Description of Effects of Embodiment 1

According to the path determination device 1, regarding the difference parts having the performance problem and the influence paths 32 influenced by the first difference part 31, the influence path can be presented to the user in a state in which an influence path that does not influence a performance problem is narrowed down. Thus, the path determination device of the present invention can facilitate identification of a cause for a program performance problem by the user.

Note that how to handle code coverage limited to a specific function in the execution phase is supplemented.

### (A) When a Partial Test is Used by Taking a Target Function as the Highest Function

When there is no performance problem, the determination unit 23 excludes the influence path 32 included in coverage information of the executed “partial test” from the influence path list 22A.

### (B) When an Overall Test is Used

In performance measurement by the performance measurement device 330, only that specific function is measured. When there is no performance problem, the determination unit 23 excludes, from the influence path list 22A, only the influence path 32 included in coverage information of the entire source code and having the specific function as the height influence destination.

Note that for acquisition of an influence path to be influenced by the difference part, code dependency analysis is used. For dependency analysis, a general technique as disclosed in the following addresses can be used.

https://www.grammatech.com/codesurfer-binaries.

http://understand.techmatrix.jp/.

In Embodiment 1, a method of determining a program performance problem by the performance measurement device 330 is not defined. As a program performance problem determination method, for example, the following determination method can be thought. By making a comparison between a numerical value of the result of a program performance test and a threshold, the performance measurement device 330 determines whether the program has a performance problem. Alternatively, the performance measurement device 330 conducts a program performance test on a new version and an old version and determines whether the new version has a performance problem based on a difference in numerical values of the test result.

<Supplement of Hardware Structure>

In the path determination device 1 of FIG. 2, the functions of the path determination device 1 are implemented by software. However, the functions of the path determination device 1 may be implemented by hardware.

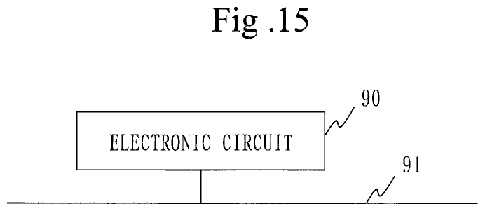

FIG. 15 illustrates a structure in which the functions of the path determination device 1 are implemented by hardware. An electronic circuit 90 of FIG. 15 is a dedicated electronic circuit which implements the functions of the first difference extraction unit 21, the path extraction unit 22, the determination unit 23, and the output unit 24 of the path determination device 1. The electronic circuit 90 is connected to a signal line 91. The electronic circuit 90 is specifically a single circuit, composite circuit, programmed processor, parallel-programmed processor, logic IC, GA, ASIC, or FPGA. GA is an abbreviation for Gate Array. ASIC is an abbreviation for Application Specific Integrated Circuit. FPGA is an abbreviation for Field-Programmable Gate Array. The functions of the components of the path determination device 1 may be implemented by a single electronic circuit or may be implemented as being dispersed into a plurality of electronic circuits. Also, the functions of part of the components of the path determination device 1 may be implemented by an electronic circuit and the remaining functions may be implemented by software.

The processor 2 and the electronic circuit 90 are each also referred to as processing circuitry. In the path determination device 1, the functions of the first difference extraction unit 21, the path extraction unit 22, the determination unit 23, and the output unit 24 may be implemented by processing circuitry. Alternatively, the functions of the first difference extraction unit 21, the path extraction unit 22, the determination unit 23, the output unit 24, the main storage device 3, the auxiliary storage device 4, the input IF 5, the output IF 6, and the communication IF 7 may be implemented by processing circuitry.

While Embodiment 1 has been described in the foregoing, one in Embodiment 1 may be partially implemented. Alternatively, two or more in Embodiment 1 may be partially combined for implementation. Note that the present invention is not limited to Embodiment 1 and can be variously changed as required.

### REFERENCE SIGNS LIST

1: path determination device; 2: processor; 3: main storage device; 4: auxiliary storage device; 5: input IF; 6: output IF; 7: communication IF; 8: signal line; 21: first difference extraction unit; 22: path extraction unit; 22A: influence path list; 23: determination unit; 24: output unit; 25: result; 30: display device; 31: first difference part; 32: influence path; 44: path determination program; 90: electronic circuit; 91: signal line; 200: program storage device; 201: source code repository; 202: execution program storage device; 210: first program; 211: source code; 212: execution program; 220: second program; 221: source code; 222: execution program; 231: first test condition; 233: first performance test; 242: second test condition; 244: second performance test; 300: external device; 310: difference extraction device; 320: coverage measurement device; 321: first coverage information; 322: second coverage information; 330: performance measurement device; 401: code

1. A path determination device comprising:
processing circuitry to:
acquire a plurality of difference parts each indicating a dissimilar part between a source code of a first program and a source code of a second program acquired by version-updating the first program and first coverage information indicating a plurality of rows executed by a first performance test for testing the second program in its entirety by using a first test condition and, with reference to the first coverage information, from the plurality of difference parts, to extract a plurality of first difference parts indicating a plurality of difference parts on which the first performance test has been executed;
extract, for each of the first difference parts, an influence path indicating a chain of a plurality of elements to be influenced by the first difference part, from a plurality of elements configuring the source code of the second program; and
acquire second coverage information indicating a plurality of rows on which a second performance test using a second test condition different from the first test condition has been conducted among a plurality of rows of the source code of the second program and to determine an influence path included in the second coverage information among the plurality of influence paths extracted for each of the first difference parts.

2. The path determination device according to claim 1, wherein
the first program is determined as satisfying a performance required for the first program by a performance measurement device which measures a performance of a program and determines whether the program satisfies a performance, and
the second program is determined as not satisfying a performance required for the second program by the performance measurement device from a measurement result of the first performance test by the performance measurement device and is determined as satisfying the performance required for the second program by the performance measurement device from a measurement result of the second performance test by the performance measurement device.

3. The path determination device according to claim 1, wherein
the processing circuitry excludes, from the plurality of influence paths, the influence path included in the second coverage information among the plurality of influence paths, and
output a result in which the influence path included in the second coverage information is excluded from the plurality of influence paths.

4. The path determination device according to claim 2, wherein
the processing circuitry excludes, from the plurality of influence paths, the influence path included in the second coverage information among the plurality of influence paths, and
output a result in which the influence path included in the second coverage information is excluded from the plurality of influence paths.

5. The path determination device according to any one of claim 1, wherein
the processing circuitry extracts a chain of functions as the influence path.

6. The path determination device according to any one of claim 2, wherein
the processing circuitry extracts a chain of functions as the influence path.

7. The path determination device according to any one of claim 3, wherein
the processing circuitry extracts a chain of functions as the influence path.

8. The path determination device according to any one of claim 4, wherein
the processing circuitry extracts a chain of functions as the influence path.

9. A non-transitory computer-readable medium storing a path determination program that causes a computer to execute:
a first difference extraction process to acquire a plurality of difference parts each indicating a dissimilar part between a source code of a first program and a source code of a second program acquired by version-updating the first program and first coverage information indicating a plurality of rows executed by a first performance test for testing the second program in its entirety by using a first test condition and, with reference to the first coverage information, from the plurality of difference parts, to extract a plurality of first difference parts indicating a plurality of difference parts on which the first performance test has been executed;
a path extraction process to extract, for each of the first difference parts, an influence path indicating a chain of a plurality of elements to be influenced by the first difference part, from a plurality of elements configuring the source code of the second program; and
a determination process to acquire second coverage information indicating a plurality of rows on which a second performance test using a second test condition different from the first test condition has been conducted among a plurality of rows of the source code of the second program and to determine an influence path included in the second coverage information among the plurality of influence paths extracted for each of the first difference parts.
